(19) United States
(12) Patent Application Publication
(10) Pub. No.: US 2013/0162445 A1
(43) Pub. Date: Jun. 27, 2013

(54) Method for Determining Traffic Flow Data in a Road Network

(71) Applicant: Kapsch TrafficCom AG, Wien (AT)

(72) Inventors: Sandford Bessler, Wien (AT); Thomas Paulin, Wien (AT); Marko Jandrisits, Wien (AT)

(73) Assignee: KAPSCH TRAFFICCOM AG, Wien (AT)

(21) Appl. No.: 13/726,276

(22) Filed: Dec. 24, 2012

(30) Foreign Application Priority Data
Dec. 27, 2011 (EP) 11195820.3

(51) Int. Cl. G08C 17/02

(52) U.S. Cl. CPC G08C 17/02
USPC 340/870.3

(57) ABSTRACT

Determining traffic flow data in a road network comprising passing a first radio beacon and receiving a request message that at least includes a start location and a stop location; determining if an on-board unit position is within a predetermined range of the start location, and responsively starting a recording of measurement data; determining if the on-board unit position is within a predetermined range of the stop location, and responsively stopping the recording of the measurement data; and transmitting the recorded measurement data to a next radio beacon that is passed by the on-board unit.

### FIELD OF THE INVENTION

Described herein are systems and methods for determining traffic flow data in a road network.

### BACKGROUND OF THE INVENTION

The term “traffic flow data” as used in this specification means all types of sensor and measurement data from and relating to vehicles of moving and stationary traffic that can be collected on the level of granularity of individual vehicles and can provide an overview of the traffic situation, the “traffic flow” in a road network or a section thereof in the form of, e.g., a statistical analysis over several vehicles.

Modern vehicles have a variety of sensors for the generation of measurement data, such as speed, acceleration and deceleration, data from the Antilock Braking System (ABS) and Electronic Stability Program (ESP) systems of the vehicle, status of the lighting and heating systems, environmental and weather data such as daylight, outside temperature, air humidity, visibility (fog), data from camera and radar systems of the vehicle for detecting the surrounding traffic and hazards, etc. The multitude of measurement data from the vehicle is further increased by measurement data of electronic accessory devices (“on-board units”, OBUs), e.g. satellite navigation receivers and/or transceivers for radio communication with roadside radio beacons (“Roadside Units”, RSUs). The term “radio beacon” as used herein refers to devices generally used to transmit and receive wireless radio signals, including wireless radio beacon signals. On-board units can receive measurement data of the vehicle as well as, by means of its own sensors, acquire measurement data relating to the vehicle and/or its environment, e.g., positions and speeds measured by means of satellite navigation from radio communications with radio beacons or mobile networks, environmental data from its own weather sensors, etc.

However, determining meaningful traffic flow data is a non-trivial problem in practice even with vehicles equipped as such. A transmission of the measurement data of all vehicles to a central analysis unit is not realistic due to the large volume of data and the limited transmission capacities of currently available wireless channels, e.g., of mobile radio systems. Moreover, the measurement data generated by the individual vehicles are highly redundant in dense traffic and of little use with “fair weather conditions” (low traffic, good weather, no incidents or accidents). Therefore, present systems for collecting traffic flow data only use a limited number of specially equipped vehicles, e.g. taxis, which go with the flow of the traffic to provide a representative picture of the traffic situation or the environmental situation. However, this firstly requires a special fleet of vehicles, and secondly requires a permanent data link from these vehicles to the analysis center, normally a data link to a wireless network, which is expensive and requires many resources.

The technical report ETSI TR 102 898 “Machine to Machine Communications (M2M); Use cases of Automotive Applications in M2M capable networks”, V 0.4.0, September 2010, Chapter 5.2.3, describes scenarios for traffic information services which distribute information from a central unit via wireless networks to OBUs, which in turn send traffic flow data to the central unit in the case of specific events. This design can be attributed to the aforementioned non-specific data collection solutions having the disadvantage of an uncontrollable high amount of data without any possibility of a location-specific access to the data-generating vehicles in the collection process.

### SUMMARY

In contrast to the systems described in the ETSI technical report, some embodiments described herein create a method for collecting traffic flow data that overcomes the said disadvantages.

This is achieved according to some embodiments by using a method for determining traffic flow data in a road network having road segments of which at least some are equipped with radio beacons for DSRC (Dedicated Short Range Communications) with vehicle-mounted on-board units, which are configured to determine their position and record measurement data of their vehicle or their environment, comprising the following steps carried out by an on-board unit:

a) passing a first radio beacon and receiving a request message, which at least includes a start location and a stop location, from the first radio beacon via a first DSRC radio communication;

b) determining if a position of the on-board unit is within a predetermined range of the start location, and starting the recording of the measurement data;

c) determining if the position of the on-board unit is within a predetermined range of the stop location, and stopping the recording of the measurement data; and

d) transmitting the recorded measurement data to the next radio beacon that is passed by the on-board unit along its way via a second DSRC radio communication.

The method according to some embodiments uses the location-based infrastructure of a network of Roadside Units as is currently already used for example in road tolling systems, traffic telematics and/or vehicle communication systems and is based on dedicated short range communications (DSRC) between vehicle-mounted OBUs and RSUs. The limited range of such DSRC radio communications permits a location-specific feed of requests for data collection into a subset of the road users of the road network, namely all vehicles moving between a start location and a stop location and serving as data sources for the determination of the traffic flow data. In this connection, the collection area is not bound to the locations of the particular RSUs, but will be defined by the self-localization of the OBUs. As a result, comprehensive, nearly continuous traffic flow data from a specific area of a wide road network can be acquired with the lowest possible storage requirements and the lowest possible load on the available communication channels, i.e. limited to DSRC radio communications between OBUs and RSUs around the collection area.

According to a further aspect of some embodiments, a method for determining traffic flow data that uses a multitude of on-board units, each of which carries out the aforementioned steps a) to d), also includes the following steps:

determining a first group of radio beacons as those radio beacons that are the last in substantially all possible access routes to the start location formed by the road segments of the road network;

providing the request message to the radio beacons of the first group; and

transmitting the request message from each radio beacon of the first group for reception by all on-board units or by at least a subset of the on-board units while passing such radio beacon according to step a).

Where a subset of the passing on-board units is used, the subset is appropriately defined as a representative selection, e.g. every second, third, tenth, hundredth, etc., of the passing on-board units.

The methods described herein can be triggered locally within a radio beacon that compiles and distributes the request message to the radio beacons of the first group. However, in some embodiments the request message is compiled in a central unit interconnected with the radio beacons and is sent by the central unit to the radio beacons of the first group. This allows a traffic control at all times to get a detailed view of the traffic situation in a section of the road network.

In further embodiments the method comprises the following additional steps:

selecting a radio beacon as a data-collecting radio beacon; and

forwarding the measurement data emitted by on-board units in their step d) from the particular receiving radio beacon to the data-collecting radio beacon.

In order to keep the data traffic between the radio beacons to a minimum, the data-collecting radio beacon is set up as near as possible to the collection area. In some embodiments this is done by applying these additional steps:

determining a second group of radio beacons as those radio beacons that are the first in substantially all possible exit routes from the stop location formed by the road segments of the road network; and

selecting the data-collecting radio beacon from the second group.

In embodiments that utilize a central data analysis technique, the measurement data is sent by the data-collecting radio beacon to the central unit for analysis.

In order to further reduce the data traffic between the data-collecting radio beacon and the central unit, some embodiments provide for the measurement data to be pre-analyzed and compressed by the data-collecting radio beacon before being sent to the central unit for analysis.

In any of the embodiments described herein, the request message may also include a specification of a type of measurement data to be recorded, while the on-board unit only records (or reports) measurement data of such type, and/or the request message can also include a specification of a period of validity, while the on-board unit only records (or reports) measurement data within such period of validity. This permits the system to further specify the requests for data collection, which allows an even more exact view of the traffic situation. The radio beacon can also interrogate an on-board unit before sending the request message to retrieve the type of measurement data collected by the on-board unit and to adapt the request message accordingly.

### BRIEF DESCRIPTION OF THE FIGURES

Further features and advantages of the invention follow from the following detailed description of various embodiments that make reference to the accompanying drawings in which:

FIG. 1 shows a schematic depiction of a road network with components used by the method described herein;

FIG. 2 shows a block diagram of one of the on-board units of the road network of FIG. 1;

FIG. 3 shows a flow chart of one of the processes running in the on-board unit of FIG. 2;

FIG. 4 shows a flow chart of one of the processes running in the road network of FIG. 1; and

FIG. 5 shows the structure of a request message for data collection in the processes of FIG. 3 and FIG. 4.

### DETAILED DESCRIPTION

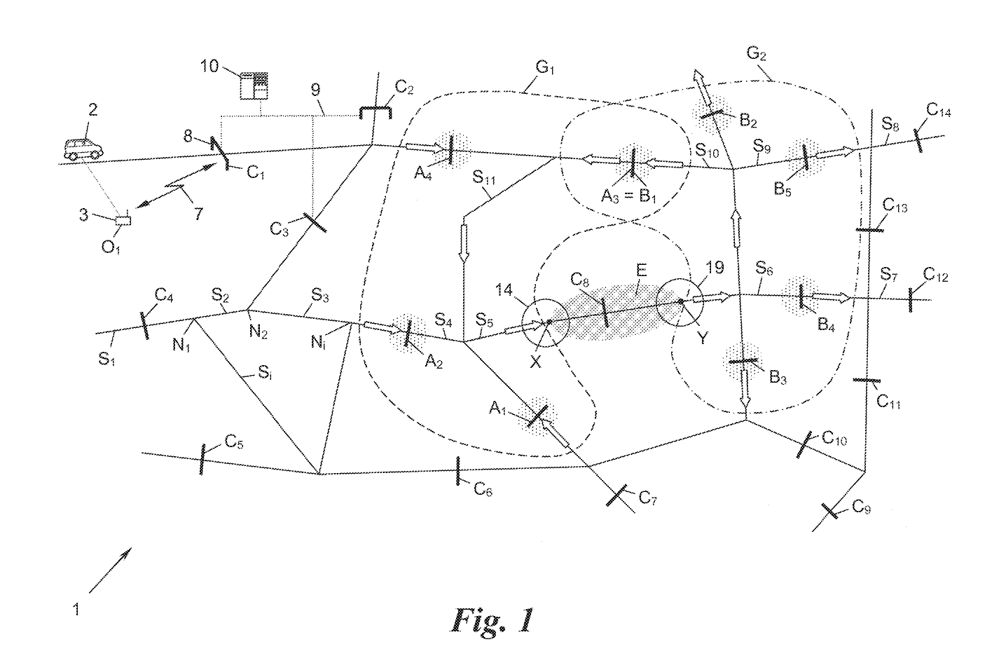

In FIG. 1, a schematic depiction of a road network 1 is depicted, comprising a multitude of road segments S₁, S₂, S₃, . . . , generally Sᵢ, between which connection points or nodes N₁, N₂, N₃, . . . , generally Nᵢ, are located. Accordingly, the road network 1 can be modeled or depicted by a corresponding network graph, as is known to those of skill in the art. It is understood that individual road segments Si can be defined for different lanes and/or directions of travel in the road network 1.

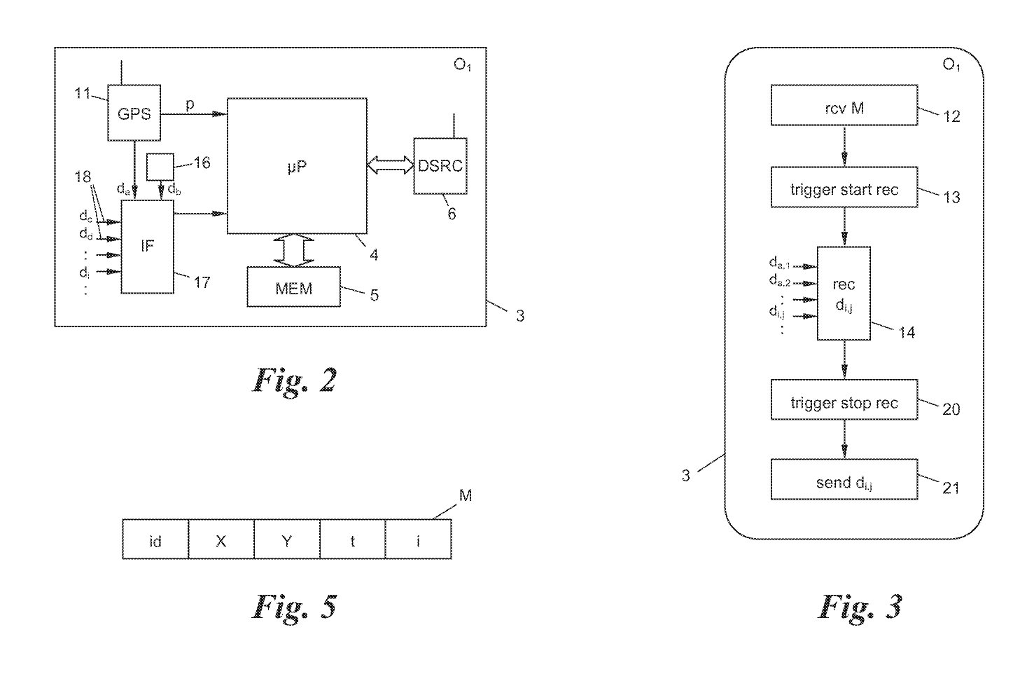

In the road network 1, there are a multitude of moving vehicles 2 (of which only one example is shown) each of which is equipped with an on-board unit (OBU) 3, here identified by the designations O₁, O₂, O₃, . . . , generally Oᵢ. In addition to a micro-processor 4 and a tangible storage medium 5, each OBU 3 has a short-range transceiver 6 (FIG. 2) via which the OBU can handle dedicated short range communications (DSRC) 7 with radio beacons 8 of the road toll systems 1.

The radio beacons 8 are locally distributed across the entire road network 1 and are designated in this example as A₁, A₂, A₃, . . . , generally A₁, B₁, B₂, B₃, . . . , generally Bᵢ, and C₁, C₂, C₃, . . . , generally Cᵢ. The radio beacons 8 are each installed as Road Side Units (RSUs) at a road segment Sᵢ, whereby also several radio beacons 8 can be installed at a road segment Sᵢ or one radio beacon 8 can cover several road segments Sᵢ.

The radio beacons 8 are interconnected e.g. via a wired data network 9 and can also be interconnected via this data network with a central unit 10 of the road network 1, for example a traffic control or toll charger (TC).

Due to the short range of the radio communications 7 between OBUs 3 and radio beacons 8, the vehicles 2 passing a radio beacon 8 can be localized on the location or radio coverage range of this radio beacon 8. The radio beacons 8 are, for example, part of a road toll system in which they localize the movements of the vehicles 2 by means of the radio communication 7, to charge the vehicles 2 for passing toll roads accordingly. Further applications of the radio beacons 8 may include, for example, the distribution of traffic information or “infotainment” to passing vehicles 2 and/or the reception of data of the passing vehicles 2.

The radio communications 7, i.e. notably the transceivers 6 of the OBUs 3 and the radio beacons 8, may work according to any of the many short range wireless standards as is known to those of skill in the art, such as the DSRC standards ITS-G5, IEEE 802.11p, WAVE (wireless access in a vehicle environment), WLAN (wireless local area network), RFID (radio frequency identification), Bluetooth®, etc. The radio range of the radio communication 7 (and the radio coverage range of the radio beacons 8) usually is some 10 to some 100 meters, but specifically with WLAN, WAVE and IEEE 802.11p can be up to some number of kilometers, and usually is not larger than the extension of the road segment Sᵢ to which the radio beacon 8 is assigned, and usually does not overlap with the radio coverage range of an adjacent radio beacon 8. It is preferably as limited as possible so as to achieve a localization of the passing vehicles 2 as precisely as possible.

The described infrastructure of the road network 1 is now used to collect traffic flow data from a narrowly limited area E of the road network 1 in the following description.

To this end, the systems and methods described herein may use specifically equipped OBUs, which are explained in detail with respect to FIG. 2 and FIG. 3. The OBUs 3 and Oᵢ as contemplated herein have the capability for both the radio communication 7 and for autonomously locating their own position p in the road network 1, namely by means of a positioning device 11. The positioning device 11 can determine the position p of the OBU 3 for example by an optical detection of specific landmarks in camera images of its environment, by means of radio triangulation in terrestrial radio networks, by means of cell detection in mobile networks, etc. The positioning device 11 in some embodiments is a satellite navigation receiver for a global navigation satellite system (GNSS), like GPS, GLONASS, GALILEO, etc.

Using the positioning device 11 every OBU 3 is capable of autonomously detecting when the collection area E is entered and is exited. For this purpose, the collection area E is defined by its start location X on the associated road segment Sᵢ and its stop location Y on this (or another) road segment Sᵢ, i.e. in the example illustrated it spreads over the road segment S₅ between the start location X and the stop location Y. In this respect it is irrelevant whether a radio beacon C₈ is located in the collection area E or not.

A location-specific distribution process—to be further outline below—which accesses the network of radio beacons 8 now provides every OBU 3 with a request for data collection from a radio beacon 8 in the form of a request message M (FIG. 5), which in some embodiments includes the start location X and the stop location Y. FIG. 3 shows the procedure triggered by such message in an OBU 3 in detail.

According to FIG. 3, in a first step 12, when passing a first radio beacon 8, the request message M is received through a (first) radio communication 7. The OBU 3 stores the start location X and the stop location Y from the request message M and it then determines and compares its own position p with the start location X in step 13. The determination may be ongoing in that periodic or sufficiently frequent assessments of its current position may be made. Once the position p gets within a (preset, or predetermined) close range 14 (FIG. 1) around the start location X, the data collection for the collection area E is started, i.e. a recording 14 of measurement data d is started.

The measurement data d recorded in the data collection process 14 may be of any of the abovementioned type i, for example position, speed or motion vector data dₐ from the positioning device 11, temperature and weather and environmental pollution data d_{b} from internal weather and pollutant sensors 16 of the OBU 3, engine or exhaust data d_{c} or ABS or ESP data d_{d} of the vehicle 2, which are received from vehicle 2 via an interface module 17 having wireless or wired interfaces 18, etc.

Thus, the recording process 14 records all measurement data d_{i,j} accumulated for one (or more) selected sensor and measurement data types i and stores such data in the storage 5 of the OBU 3 on an ongoing basis, i.e. continuously or at discrete times j. The selected measurement data type(s) i may be for example predefined or only forwarded in a request message M of the OBU 3.

If the request message M also includes a period of validity t, the individual OBUs 3 or Oᵢ may also check and ensure in the recording process 14 that measurement data d_{i,j} is only recorded within the period of validity t.

The collection process 14 is terminated once the positioning device 11 detects the entry into a (preset or predetermined) close range 19 of the stop location Y (step 20). The close ranges 14, 19 around the start location X and the stop location Y serve as a tolerance for measuring inaccuracies of the positioning device 11 and are minimized according to the accuracy of the positioning device 11 so as to define the collection area E as accurately as possible.

Afterwards, the measurement data recorded in step 14 is sent in a step 21 to the next best radio beacon 8, which the OBU 3 meets on its way, via a (second) radio communication 7.

Should for any reason the stop location Y not be detected within a preset distance from the start location X or within a reasonable time, e.g. within the period of validity t, the request message M and the recorded measurement data d_{i,j} may be deleted in the OBU in certain embodiments.

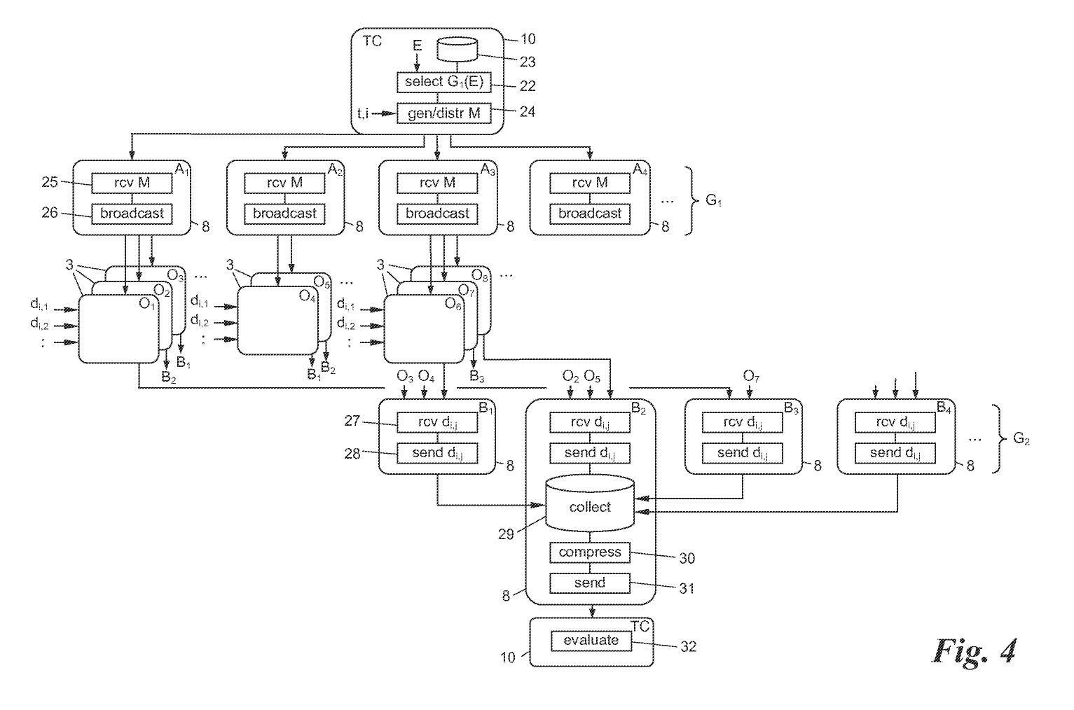

A large number of OBUs 3, which, when passing the collection area E, execute the procedure shown in FIG. 3, may determine traffic flow data related to the collection area E, thus creating a detailed picture of the traffic situation in the collection area E. The execution of the data collection request necessary in step 12 and the data return in step 21 is now explained in detail with reference to FIG. 4 for the entire road network of FIG. 1.

FIG. 4 shows the principle of the location-specific feed of data collection requests M into the road network 1 by means of the network of distributed radio beacons 8. The procedure starts in the central unit 10 of the network 9 of radio beacons 8, where the central unit 10 could also be implemented by, or integrated within, one of the radio beacons 8.

Given the relevant collection area E, a first group G₁ of (first) radio beacons 8, depicted in FIG. 4 as the radio beacons A₁, A₂, A₃ and A₄, is selected in a first step 22 which serves to feed in the request messages M into the passing OBUs 3. The first group G₁ is composed of those radio beacons 8 that are the last in substantially all possible access routes via which the start location X of the collection area E can be reached (“substantially all possible access routes” includes the major access routes. In the example of FIG. 1, the radio beacons C₄ and A₂ are in the access route S₁-S₂-S₃-S₄-S₅ to the start location X, with the radio beacon A₂ being the last located in the access route. In the alternatively possible access route S₈-S₉-S₁₀-S₁₁-S₅ to the start location X, there are for example located the radio beacons C₁₄, B₅ and A₃=B₁, of which radio beacon A₃=B₁ is the last. Accordingly, the said radio beacons A₁, A₂, A₃=B₁ and A₄ follow as the first group G₁ over all possible access routes to the start location X.

The selection of the radio beacons 8 for the group G₁ in step 22 can for example be made by means of known algorithms of the graph theory from a network graph model of the road network 1, which is e.g. deposited in a database 23 of the central unit 10.

In a subsequent step 24, the request message M is compiled and may also include, for example, a period of validity t, e.g. in the form of an expiry time. The request message M is then distributed in step 24 by the central unit 10 via the data network 9 to all radio beacons 8 of the first group G₁, which receive this message in a receive step 25.

The radio beacons 8 and A₁, A₂, A₃, A₄ of the first group G₁ subsequently send the request message M to every OBU 3 passing them in a step 26; every OBU 3 receives the request message M in step 12 (FIG. 3).

In some alternative embodiments, the radio beacons 8 of the first group G₁ can send the request message M not to all, but only to a subset of the passing OBUs 3, e.g. to every second, third, tenth, hundredth, etc., passing OBU 3.

FIG. 4 shows an exemplary scenario, in which the radio beacon A₁ is consecutively passed by three OBUs O₁, O₂, O₃, while the radio beacon A₂ is consecutively passed by two OBUs O₄, O₅; and the radio beacon A₃ is consecutively passed by three OBUs O₆, O₇, O₈. It is understood that the send and receive steps 26, 12 each are triggered when an OBU 3 passes a radio beacon 8, i.e. at different times. As long as a radio beacon 8 of the first group G₁ does not receive an instruction to the contrary from the central unit 10, it continues with the transmission 26 of request message M to all passing OBUs 3. Such an instruction to the contrary, i.e. a request to the radio beacons 8 of the first group G₁ to stop the send step 26, can for example be issued by means of a deactivation message sent by the central unit 10 to the radio beacons 8 of the first group G₁ regarding the previously sent request message M, for which purpose the request messages M can also be referenced through unique identifiers id.

Every OBU 3 (here O₁ to O₈) which has received a request message M, is carrying out the data collection process as already explained by means of FIG. 3, i.e. every OBU 3 is recording sensor data d_{i,j} between the start location X and the stop location Y and delivers the recorded sensor data d_{i,j} to the next radio beacon 8 on its route (step 21). All possible next radio beacons 8 that in this way can receive measurement data d_{i,j} from an OBU 3 form a second group G₂ (FIG. 1).

The second group G₂ is composed of all those radio beacons 8 that are the first in the exit routes (leaving routes) from the stop location Y. For instance, in the exit route S₅-S₆-S₇ from the stop location Y, the radio beacons B₄ and C₁₂ are present with the radio beacon B₄ being the first; therefore, the radio beacon B₄ is the radio beacon to which the OBU 3 will transmit its recorded measurement data d_{i,j} in the step 21. Thus, the radio beacons B₁=A₃, B₂, B₃, B₄, B₅ of the second group G₂ as depicted in FIG. 1 follow from all possible exit routes from the stop location Y. FIG. 4 shows the receive step 27 in the radio beacons 8 (here B₁, B₂, B₃, B₄, B₅) of the second group G₂ associated with the send step 21.

For analysis of the collected measurement data d_{i,j} of all OBUs Oᵢ, the radio beacons 8 of the second group G₂ are now sending all measurement data d_{i,j}(Oᵢ) in a send step 28 either directly to the central unit 10 or—as in the depicted embodiment—to a selected “data-collecting” radio beacon 8 of the second group G₂, here radio beacon B₂, i.e. more precisely to a data collection process (“container”) 29 in the data-collecting radio beacon B₂, which can carry out a pre-analysis and data compression of the collected measurement data d_{i,j}(Oᵢ), e.g. a statistical analysis, in embodiments that perform a pre-analysis step 30. The collected and in some embodiments, pre-analyzed, measurement data d_{i,j}(Oᵢ) is subsequently sent to the central unit 10 in a step 31 for final analysis 32.

The analysis in step 32 can for example determine a traffic density and/or mean traffic flow speed in the collection area E, generate traffic jam forecasts, also on the basis of weather measurement data, deceleration measurement data, etc., and generally on the basis of all aforementioned types i of the measurement data d_{i,j} and its courses recorded over the time j.

The invention is not limited to the embodiments as presented, but comprises all versions and modifications covered by the appended claims.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the systems may be implemented using a general purpose or dedicated processor device running a software application or program code stored in volatile or non-volatile memory devices. Devices so programmed may be used to perform the methods described herein. Also, the hardware objects could communicate using electrical signals, with states of the signals representing different data.

It should be further understood that these and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

We claim:

1. A method for determining traffic flow data in a road network with road segments of which at least some are equipped with radio beacons for DSRC radio communications with vehicle-mounted on-board units, which are configured to determine their position and record measurement data of their vehicle or their environment, comprising the following steps carried out by an on-board unit:
a) passing a first radio beacon and receiving a request message, which at least includes a start location and a stop location, from the first radio beacon via a first DSRC radio communication;
b) determining if a position of the on-board unit is within a predetermined range of the start location, and starting recording of measurement data;
c) determining if the position of the on-board unit is within a predetermined range of the stop location, and stopping the recording of the measurement data; and
d) transmitting the recorded measurement data to a next radio beacon that is passed by the on-board unit along its way via a second DSRC radio communication.

2. The method according to claim 1 using a plurality of on-board units each of which carries out the steps a) to d), further comprising:
determining a first group of radio beacons comprising those radio beacons that are the last in substantially all possible access routes to the start location formed by road segments of the road network;
providing the request message to the radio beacons of the first group; and
transmitting the request message from each radio beacon of the first group to at least a subset of the on-board units passing such radio beacon according to step a).

3. The method according to claim 2, wherein the request message is compiled in a central unit interconnected with the radio beacons and is sent by the central unit to the radio beacons of the first group.

4. The method according to claim 2, further comprising:
selecting a radio beacon as a data-collecting radio beacon; and
forwarding the measurement data transmitted by on-board units in its respective step d) from the particular receiving radio beacon to the data-collecting radio beacon.

5. The method according to claim 4, further comprising:
determining those radio beacons that are the first in substantially all possible exit routes from the stop location formed by the road segments of the road network, as a second group of radio beacons; and
selecting the data-collecting radio beacon from the second group.

6. The method according to claim 4 wherein the measurement data is sent by the data-collecting radio beacon to a central unit for analysis.

7. The method according to claim 6, wherein the measurement data is pre-analyzed and compressed by the data-collecting radio beacon, before the data is sent to the central unit for analysis.

8. The method according to claim 1 wherein the request message also includes a specification of a type of measurement data to be recorded, with the on-board unit only recording measurement data of this type.

9. The method according to claim 8wherein the radio beacon interrogates an on-board unit before sending the request message to retrieve the type of measurement data collected by that on-board unit, whereupon the request message is adjusted accordingly.

10. The method according to claim 1 wherein the request message also includes a specification of a period of validity, with the on-board unit only recording measurement data within such period of validity.

11. The method according to claim 1 wherein the position of the on-board unit is determined by means of satellite navigation.

12. The method according to claim 1 wherein the measurement data comprise speed and/or deceleration data of the on-board unit or its vehicle.

13. The method according to claim 1 wherein the measurement data comprise weather data from an environment of the on-board unit or its vehicle.

14. The method according to claim 1 wherein the measurement data comprise pollutant emission data from an environment of the on-board unit or its vehicle.
